(19) United States
(12) Patent Application Publication
(10) Pub. No.: US 2005/0174357 A1
(43) Pub. Date: Aug. 11, 2005

(54) Automatic attribute adjusting blue tooth wireless communication device

(76) Inventor: Tai-Chang Wang, Taipei (TW)

Correspondence Address: SUPREME PATENT SERVICES, POST OFFICE BOX 2339, SARATOGA, CA, 95070, US

(21) Appl. No.: 10/862,808

(22) Filed: Jun. 5, 2004

(30) Foreign Application Priority Data
Feb. 11, 2004 (TW) 093201926

(51) Int. Cl. G06F 15/16; G09G 5/00

(52) U.S. Cl. 345/581

(57) ABSTRACT

An automatic attribute adjusting Blue Tooth wireless communication device is disclosed, which adjusts itself to appropriate attribute based on the attribute of the electronic device it connects, so as to enable the said electronic device to exchange Blue Tooth wireless packets with another electronic device containing the Blue Tooth wireless communication capability. The attribute denotes one of the Master and Slave. The Blue Tooth wireless communication device disclosed by the present invention comprises USB interface, attribute control module, and Blue Tooth module. Wherein, the attribute control module is used to obtain the attribute of the electronic device via the USB interface, and based on the attribute obtained to set the attribute of the automatic attribute adjusting Blue Tooth wireless communication device to the attribute corresponding to that of the said electronic device, so as to enable the Blue Tooth wireless communication device to exchange data with the said electronic device.

### BACKGROUND OF THE INVENTION

1. Field of the Invention

The present invention relates to a Blue Tooth wireless communication device, and in particular to an automatic attribute adjusting Blue Tooth wireless communication device.

2. The Prior Arts

At the end of year 2001, the USB implementers forum (USB IF) announced the USB2.0 supplementary specification USB OTG (On-The-Go) and its main features consist in enabling the attributes of the USB device to be switched between the Master (Host) and the Slave (Device). USB devices of this kind are all equipped with a Mini-AB insertion slots. Therefore, when connecting two USB devices with a Mini-A to Mini-B cable, the users usually will not notice the differences between the two devices (device A and device B), neither will they pay attention to the attributes of Master and Slave they acquiesce respectively. If device A and device B are both in compliance with USB OTG, then they can exchange their own attributes through Master Negotiation Protocol (HNP). If one of the device A and device B is USB OTG, while the other is ordinary USB device, then they discriminate the attribute of the device of USB OTG to be Master or Slave to suit to the attribute of its counterpart through the high or low of the ID signal on the USB port, instead of carrying on the negotiation procedure through the HNP. However, usually the predetermined attribute of the USB OTG is Master.

The differences of the above-mentioned USB devices of attribute Master or attribute Slave lie in that the Master must provide power supply for the Bus Bar in the process of data mutual transfer. Therefore, in other words, it explains the fact that the connection relation of the two devices is not reciprocal. The device of attribute Master is responsible for providing power supply for the Bus Bar, and therefore it controls the timing of the occurrences of the communication; and the device of attribute Slave can only request the device of attribute Master to initiate the communication through the Session Request Protocol (SRP).

However, the USB device of the prior art utilizes the chip providing the USB OTG function, but still subjects to the restriction that, it must mutually transfer data with another electronic device containing the USB interface in a direct connection manner through wire cable or USB interface.

Even if the electronic device is additionally equipped with the Blue Tooth wireless communication device, and through which to mutually transfer data with other electronic devices by means of the Blue Tooth wireless communication. However, this kind of electronic devices are only restricted to those of attributes Masters, such as, computer, PDA, mobile telephone and digital camera. But, up to the present time, there is still no Blue Tooth wireless communication device available that can be matched to use with the device of attribute Slave, for example, flash disk, digital camera, audio device such as microphone, modem, man-machine-interface device such as mouse, screen, and printer, etc., and thus making the electronic device of attribute Slave can only be utilized through the electronic device of attribute Master. In other words, these electronic devices originally with wire cannot be converted into the electronic devices with wireless communication capability even through additionally installing Blue Tooth wireless communication device.

Therefore, there exists strong demand in the consumer market that, the Blue Tooth wireless communication device must enable the electronic device to have the Blue Tooth wireless communication capability, regardless of its attribute is Master or Slave.

### SUMMARY OF THE INVENTION

Therefore, the objective of the present invention is to provide an automatic attribute adjusting Blue Tooth wireless communication device, which can enable the electronic device to have the Blue Tooth wireless communication capability regardless of its attribute is Master or Slave.

In accordance with the above-mentioned objective, the present invention provides an automatic attribute adjusting Blue Booth wireless communication device, which can be automatically adjusted into proper attribute according to the attribute of the electronic device it is connected, so as to enable this electronic device to mutually transfer the Blue Tooth wireless package with another electronic device with the Blue Tooth wireless communication capability. The above-mentioned attributes include the Master and the Slave.

The Blue Tooth wireless communication device as disclosed by the present invention includes: USB interface, attribute control module, and Blue Tooth module, wherein the attribute control module is used to obtain the attribute of that electronic device via that USB interface, and based on the attribute obtained to set the attribute of the automatic attribute adjusting Blue Tooth wireless communication device to the attribute corresponding to that of that electronic device, so as to enable the Blue Tooth wireless communication device and that electronic device to mutually transfer data.

The advantages and spirit of the present invention can be better and more thoroughly understood through the following detailed description and the attached drawings.

### BRIEF DESCRIPTION OF THE DRAWINGS

The related drawings in connection with the detailed description of the present invention to be made later are described briefly as follows, in which:

FIG. 1 is a block diagram of an embodiment of the Blue Tooth wireless communication device of the present invention; and

FIG. 2 is a block diagram of another embodiment of the Blue Tooth wireless communication device of the present invention.

### DETAILED DESCRIPTION OF THE PREFERRED EMBODIMENTS

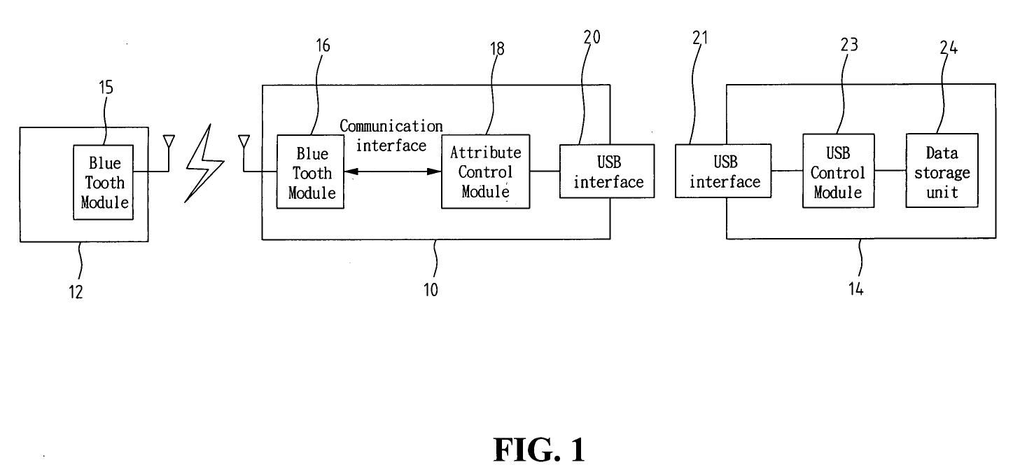

Referring to FIG. 1, the automatic attribute adjusting Blue Tooth wireless communication device 10 of the present invention can enable the electronic device 14 of either Master attribute or Slave attribute to have the Blue Tooth wireless communication capability, under the condition of regardless of the attribute of the electronic device 14 (for example, computer or digital camera) it is connected, such that the data in the data storage unit 24 in the electronic device 14 can be exchanged with the data contained in another electronic device 12 (for example, computer or PDA, etc.) with operation processing capability. The above-mentioned data storage unit 24 is in compliance with the USB mass storage device specification, for example, hard disk drive, memory, etc. And the following will describe further in detail the various components of the Blue Tooth wireless communication device 10, and how these components cooperate to achieve the above-mentioned operations.

The Blue Tooth wireless communication device 10 at least comprises the USB interface 20, the attribute control module 18, and the Blue Tooth module 16. The USB interface 20 is used to connect to the USB interface 21 of the electronic device 14. The attribute control module 18 is used to obtain the attribute of the electronic device 14 via USB interface 20, and based on the attribute obtained to set the attribute of the automatic attribute adjusting Blue Tooth wireless communication device 10 to the attribute corresponding to that of the electronic device 14, such that the Blue Tooth wireless communication device 10 and the electronic device 14 can exchange data with each other. The Blue Tooth module 16 is used to receive/transmit Blue Tooth wireless packet with another electronic device 12, and to communicate with the attribute control module 18 through the communication interface such as, the UART interface, USB interface or I2C bus bar, etc. And the Blue Tooth wireless packet and data are exchanged with each other in the communication interface. From the viewpoint of the software structure, this is performed through the interface manipulator at the Blue Tooth end and the interface controller at the OTG end. If UART interface is used as the communication interface, then the interface manipulator at the Blue Tooth end is UART manipulator, and the interface controller at the OTG end is UART controller, and the rest can be inferred from the above.

Since the attribute control module 18 of Blue Tooth wireless communication device 10 in the present invention utilizes the conventional USB OTG chips. By means of these chips, the Blue Tooth wireless communication device 10 does not have to consider the attribute of the electronic device 14 it is connected, and can automatically switch the attribute of the Blue Tooth wireless communication device 10, based on the characteristic of the electronic device 14 it is connected and the conditions of the data exchange, so as to suit the attribute of the electronic device 14, such that the Blue Tooth wireless communication device 10 and the electronic device 14 can exchange data with each other.

Specifically speaking, when the Blue Tooth wireless communication device 10 is connected to the electronic device 14 (such as, flash disk, digital camera, etc.) of attribute Slave through the respective USB interface 20 and 21, the digital file of the data storage unit 24 stored in the electronic device 14 is transmitted to the Blue Tooth wireless communication device 10 via its USB control module 23, and then through the Blue Tooth module 16 in the Blue Tooth wireless communication device 10, and transmit to another electronic device 12 with the Blue Tooth module 15 at the remote end, it can transmit out the digital data file without necessitating that it occurs only after through the direct connection with the USB interface 21 of the electronic device 14. Conversely, the electronic device 14 with the Blue Tooth wireless communication device 10 is able to receive the data from another electronic device 12 through the Blue Tooth wireless communication.

In addition, for convenience's sake, the automatic attribute adjusting Blue Tooth wireless communication device 10 of the present invention can also be applied to the electronic device 14 of Master attribute, such as computer, PDA, mobile phone and digital camera, and it can likewise enable them to have Blue Tooth wireless communication capability. As such, the automatic attribute adjusting Blue Tooth wireless communication device 10 of the present invention can become the ordinary Blue Tooth wireless communication device and electronic device 14.

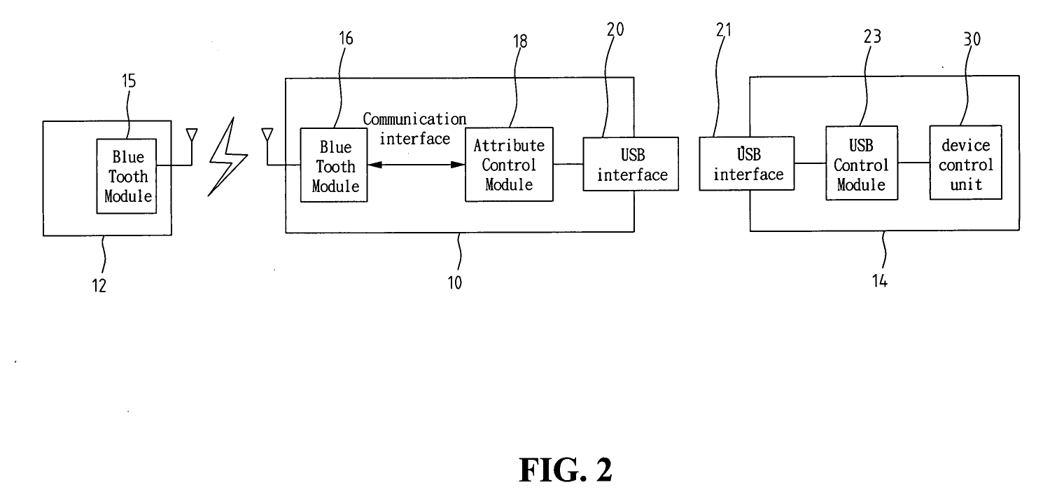

Referring to FIG. 2, another embodiment of the Blue Tooth wireless communication device of the present invention is shown. The electronic device 14 connected to the Blue Tooth wireless communication device 10 of the present invention may not contain the data storage unit 24 as shown in FIG. 1 either, instead it can be the computer peripheral equipment with USB interface for example, the audio device such as microphone, modem, man-machine interface device such as mouse, screen, printer, and USB hub, etc. When these computer peripheral equipment is connected with the Blue Tooth wireless communication device 10 of the present invention using the respective USB interface, which can convert the original wire computer peripheral equipment into wireless computer peripheral equipment, through the Blue Tooth wireless communication capability provided by the present invention. Furthermore, it can convert the device that originally must be connected to another device such as computer of attribute Master and only then it can be utilized, into the device that can directly be utilized without such connection. Correspondingly, various profiles are defined in the Blue Tooth communication protocol, to handle the signals transmitted from the above-mentioned computer peripheral equipment, and thus to communicate with the remote end electronic device. As to the audio device, it is handled by the Blue Tooth communication protocol using the Headset profile; the modem is handled by using the DUN profile; the man-machine interface device is handled by using the HID profile; the printer is handled by using HCRP or BPP; the USB mass storage device is handled by using one of FPT, SYNC, SPP, and OPP.

Specifically speaking, when the electronic device 14 such as printer is connected to the Blue Tooth wireless communication device 10 of the present invention, another electronic device 12 such as digital camera is able to transmit the digital images contained therein to the electronic device 14 such as printer through the Blue Tooth module 15 built in or outside attached to the electronic device 12. Thus, the electronic device 14 is able to directly print the digital images with paper through the device control unit 30 contained therein. If the electronic device 14 is screen, then the electronic device 12 such as the digital camera is able to display the digital images on the electronic device 14 such as the screen, through the Blue Tooth wireless communication device 10 of the present invention.

It must be emphatically pointed out that, as to the other matching application methods of the computer peripheral equipment with USB interface and the Blue Tooth wireless communication device 10 of the present invention, they all belong to the scope of claim and protection of the present invention. In addition, the operation details mentioned above have already been disclosed in the USB specification, USB OTG specification, and the Blue Tooth specification, and they will not be described in detail here for brevity's sake.

Summing up the above, the automatic attribute adjusting Blue Tooth wireless communication device 10 of the present invention can enable the electronic device 14 of the attribute Slave or the electronic device 14 of the attribute Master both be able to have the Blue Tooth wireless communication capability through its characteristic of adjustable attribute. As to the user of the present invention, the acquisition of the automatic attribute adjusting Blue Tooth wireless communication device 10 of the present invention enables him/her not have to utilize different Blue Tooth wireless communication device 10 just to correspond to the electronic device 14 of different attribute, and thus can raise its convenience in usage.

Through the above-mentioned detailed description of the preferred embodiment, the features and spirit of the present invention can be more clearly depicted. The purpose of the above-mentioned disclosure of the preferred embodiments is not intended to be restrictive to the scope of the present invention. But on the contrary, its purpose is intended to cover all the changes and the equivalent arrangements that fall into the scope of the appended claims of the present invention.

1. An automatic attribute adjusting Blue Tooth wireless communication device adapted to be connected to an external electronic device and perform automatic adjustment to appropriate attributes according on attribute of the electronic device so as to enable the electronic device to exchange the Blue Tooth wireless packet with another electronic device containing the Blue Tooth wireless communication capability, the attribute denoting one of Master and Slave, the automatic attribute adjusting Blue Tooth wireless communication device comprising:
a USB interface connectable to a USB interface of the electronic device;
an attribute control module obtaining the attribute of the electronic device via the USB interface, and based on the attribute obtained to set the attribute of the automatic attribute adjusting Blue Tooth wireless communication device to the attribute corresponding to that of the said electronic device, so as to enable the exchange of data between the Blue Tooth wireless communication device and the electronic device; and
a Blue Tooth module receiving/transmitting the Blue Tooth packet from/to another electronic device, and to exchange between the Blue Tooth wireless packet and the said data.

2. The automatic attribute adjusting Blue Tooth wireless communication device as claimed in claim 1, wherein when the attribute of the electronic device is Master, the electronic device is one of the following: a computer, a PDA, a mobile telephone, a digital camera, and a USB hub.

3. The automatic attribute adjusting Blue Tooth wireless communication device as claimed in claim 1, wherein when the attribute of the electronic device is Master, the attribute control module sets the attribute of the automatic attribute adjusting Blue Tooth wireless communication device to Slave.

4. The automatic attribute adjusting Blue Tooth wireless communication device as claimed in claim 1, wherein when the attribute of the electronic device is Slave, the electronic device is one of the following: a flash disk, a digital camera, an audio device, a modem, a man-machine interface device, a screen, and a printer.

5. The automatic attribute adjusting Blue Tooth wireless communication device as claimed in claim 1, wherein when the attribute of the electronic device is Slave, the attribute control module sets the attribute of the automatic adjusting attribute Blue Tooth wireless communication device to Master.

6. The automatic attribute adjusting Blue Tooth wireless communication device as claimed in claim 1, wherein the attribute control module is OTG USB type chip.
